(19) United States
(12) Patent Application Publication
(10) Pub. No.: US 2024/0259528 A1
(43) Pub. Date: Aug. 1, 2024

(54) PROVISION SYSTEM AND CONTROL METHOD FOR SAME

(71) Applicant: CANON KABUSHIKI KAISHA, Tokyo (JP)

(72) Inventor: HIROYUKI OKAMOTO, Kanagawa (JP)

(21) Appl. No.: 18/411,310

(22) Filed: Jan. 12, 2024

(30) Foreign Application Priority Data
Feb. 1, 2023 (JP) 2023-014029

(51) Int. Cl. H04N 7/15; G06T 17/00; G06V 40/20; H04N 7/14

(52) U.S. Cl. CPC H04N 7/157; G06T 17/00; G06V 40/20; H04N 7/147; H04N 7/152

(57) ABSTRACT

A virtual space provision system providing a virtual space and a shared service avatar capable of receiving contact from a user avatar in the virtual space has a sharing state management unit that controls audio sharing between a plurality of users respectively operating a plurality of user avatars if a plurality of user avatars operated by users are present in a virtual space. In response to detection of contact with the shared service avatar by a user avatar of the plurality of user avatars, the sharing state management unit performs control such that audio sharing with the plurality of users via a user avatar which has come into contact with the shared service avatar is temporarily canceled.

### BACKGROUND OF THE INVENTION

### Field of the Invention

The present invention relates to rendering control in a virtual space.

### Description of the Related Art

Technologies such as virtual reality (VR), augmented reality (AR), and mixed reality (MR) creating spaces providing simulated experiences by fusing real and virtual worlds are attracting attention. XR is a general term for these. In addition, in recent years, virtual spaces and services utilizing such technologies called metaverses have come to be utilized not only for entertainment purposes such as games but also in business settings such as virtual offices and VR conference rooms. In a virtual space, each user wears a head mounted display (HMD) or the like and communicates with avatars of other users in the virtual space via the HMD as if in a real space. A communication partner is not limited to only an avatar of a user. For example, a service or a system can be operated by performing communication (audio input) with a user interface (UI) of the service or the system or an artificial intelligence (AI) avatar. In a virtual space with a plurality of communication partners, it is necessary to help users communicate with each other and improve user experiences. Japanese Patent Laid-Open No. 2022-002387 discloses a technology for deciding whether or not a conversation is possible depending on the distance between users in a virtual space and adjusting the volume during a conversation.

However, in the case where audio is input to a shared service avatar, if other user avatars are present nearby, input contents will be heard by them. If it is desired to prevent confidential information, private contents, or the like from being heard by other users, in the technology of Japanese Patent Laid-Open No. 2022-002387, audio cannot be input to a shared service avatar if other user avatars are present nearby. In addition, if a plurality of users use the same shared service avatar at the same time, there is a probability that audio of other user avatars will become a disturbance.

### SUMMARY OF THE INVENTION

The present invention provides a provision system capable of controlling audio sharing in a virtual space.

A provision system of the present invention provides a virtual space and a shared service avatar capable of receiving contact from a user avatar in the virtual space. The provision system has a memory storing instructions; and a processor executing the instructions causing the provision system to: control audio sharing between a plurality of users respectively operating a plurality of user avatars if a plurality of user avatars operated by users are present in a virtual space; and detect contact with the shared service avatar by a user avatar of the plurality of user avatars. In response to detection of the contact, the processor performs control such that audio sharing with the plurality of users via a user avatar which has come into contact with the shared service avatar is temporarily canceled.

Further features of the present invention will become apparent from the following description of exemplary embodiments with reference to the attached drawings.

### BRIEF DESCRIPTION OF THE DRAWINGS

FIG. 1 shows an overall constitution of a virtual space management system.

FIG. 2 is a view showing a hardware constitution of a client terminal.

FIG. 3 is a view showing a hardware constitution of a virtual space provision system.

FIG. 4 is a view showing a software constitution of the system.

FIGS. 5A to 5D are views showing examples of screens of the client terminal according to Example 1.

FIG. 6 is a sequence diagram of audio sharing control between users according to Example 1.

FIGS. 7A and 7B are flowcharts of audio sharing control between users according to Example 1.

FIGS. 8A and 8B are views showing examples of screens of the client terminal according to Example 2.

FIG. 9 is an overall sequence of audio sharing control between users according to Example 2.

FIGS. 10A and 10B are flowcharts of audio sharing control between users according to Example 2.

### DESCRIPTION OF THE EMBODIMENTS

### Example 1

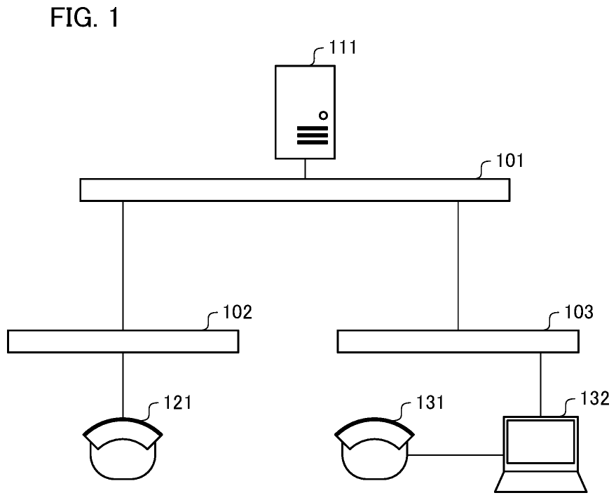

FIG. 1 is a view showing an overall constitution of a system which provides and manages a virtual space. A plurality of user avatars respectively operated by users are present in a virtual space, and communication can be performed with avatars of other users, a UI of a service or a system, or AI avatars. Hereinafter, an avatar of a user operating in a virtual space will be referred to as a user avatar, and a UI of a service or a system and an AI avatar will be referred to as a shared service avatar or a system avatar. In addition, in the present Example, as an example of communication with a user avatar or a shared service avatar, a case where communication is performed by means of audio will be described as an example.

The system related to a virtual space includes a virtual space provision system 111 providing a virtual space, and client terminals capable of projecting a virtual space provided from the virtual space provision system 111 in a real world. In the present embodiment, regarding client terminals, an example in which a client terminal 121, a client terminal 131, and a client terminal 132 are connected to the virtual space provision system 111 via networks 101 to 103 will be described.

For example, the network 101 is the internet. For example, the network 102 and the network 103 are the internet or wireless LANs set in networks in ordinary home or firms. For example, the networks 101 to 103 are so-called communication networks realized by a LAN such as the internet, a WAN, a telephone line, a dedicated digital line, an ATM, a frame relay line, a cable TV line, a wireless line for data broadcasting, or the like. The networks 101 to 103 need only be able to transmit and receive data.

The client terminal 121, the client terminal 131, and the client terminal 132 are terminals capable of capturing images of a real world, displaying a virtual space, and communicating with the virtual space provision system 111 in order to project a virtual space in a real world. The client terminal 121, the client terminal 131, and the client terminal 132 have applications for displaying a virtual space in a real world.

For example, the client terminal 121 and the client terminal 131 are dedicated hardware such as head mounted displays (HMDs) and smart glasses for drawing of virtual objects handled in XR. The client terminal 121 and the client terminal 131 may be mobile terminals such as smartphones with a built-in program execution environment. In addition, the client terminal 121 and the client terminal 131 each include a camera for capturing images of surroundings, a microphone for inputting audio, and a display for displaying virtual objects. The client terminal 121 and the client terminal 131 recognize the fingers of a user through the camera and superimpose motions in a real space and motions in a virtual space, thereby providing simulated experiences in which real and virtual worlds are fused. If the client terminal 121 and the client terminal 131 are not dedicated hardware having an application, drawing of virtual objects may be performed by utilizing a web browser or an API provided by an OS or the like. In the present Example, the client terminal 121 and the client terminal 131 will be described as HMDs.

The client terminal 132 is an information processing device such as a notebook PC (personal computer), a desktop PC, or a smartphone having a display. The HMD may perform processing independently as in the client terminal 121 or may perform processing by linking the HMD and a PC as in the client terminal 131 and the client terminal 132.

The virtual space provision system 111 provides a service of providing a virtual space to external client terminals. For example, the virtual space provision system 111 is established using a server computer. In the present embodiment, an example in which service of providing a virtual space is provided by the virtual space provision system 111 will be described, but it is not limited to this. The service or the function provided by the virtual space provision system 111 may be realized by not only one or a plurality of information processing devices but also a virtual machine (cloud service) utilizing resources provided by a data center including information processing devices or a combination of these.

In addition, in a virtual space, the virtual space provision system 111 also provides virtual objects and shared service avatars capable of receiving contact from a user avatar in the virtual space. The virtual space provision system 111 also provides positional information and sound of virtual objects and shared service avatars as a part of a service of providing virtual objects and avatars. Moreover, the virtual space provision system 111 also performs management of users utilizing the client terminals 121, 131, and 132. In a specific example, the virtual space provision system 111 receives a login/logout request of the client terminals 121 and 132 and performs login/logout processing.

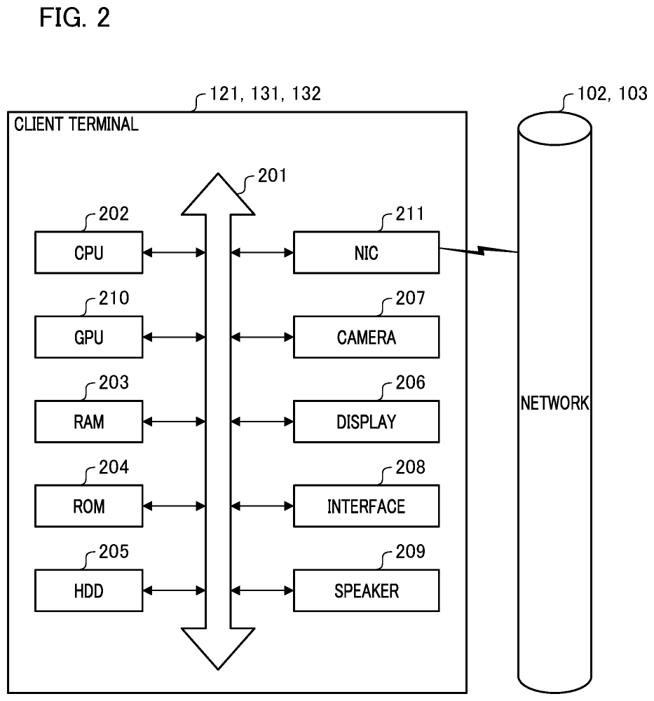

The hardware constitutions of the client terminal 121, the client terminal 131, and the client terminal 132 will be described using FIG. 2. FIG. 2 is a view of a hardware constitution of a client terminal. The client terminal has a CPU 202, a GPU 210, a RAM 203, a ROM 204, an HDD 205, a camera 207, a display 206, an interface 208, a speaker 209, and an NIC 211. These are connected to a system bus 201.

The central processing unit (CPU) 202 controls all the terminals. The graphics processing unit (GPU) 210 performs arithmetic processing necessary for drawing of virtual objects and avatars in real time. The random access memory (RAM) 203 is a temporary storage means and functions as a main memory, a work area, and the like of the CPU 202 and the GPU 210. The read only memory (ROM) 204 is a data read-only memory and stores various kinds of data such as a basic I/O program. The hard disc drive (HDD) 205 is a mass memory and stores application programs of the web browser and the like, an operating system (OS), related programs, various kinds of data, and the like. The HDD 205 is an example of a storage device and it may be a memory such as a solid-state drive (SSD) or an external storage device. The CPU 202 comprehensively controls every unit connected to the system bus 201 by loading and executing the program, which is stored in the memory (the ROM 204 or the HDD 205), in the RAM 203.

The display 206 is a display means for displaying virtual objects, information necessary for an operation, and the like. If the client terminals are smartphones, tablet PCs, or the like, the display 206 may be a touch panel in which a display means and an input means are integrated. By associating input coordinates and display coordinates in the touch panel, it is possible to constitute a GUI as if a user could directly operate a screen displayed in the touch panel.

The camera 207 is a rear camera capturing surrounding images, a front camera mainly capturing images of himself/herself, or the like. Motions of the fingers in a real space and the fingers of a user avatar in a virtual space can be synchronized by analyzing images captured by the camera 207 using the application program stored in the HDD 205. In addition, by analyzing images captured by the camera 207 using the application program stored in the HDD 205, it is possible to dispose virtual objects superimposed on a real world, and it is possible to calculate the feature quantities of a real world. If the client terminals are dedicated terminals for XR (HMDs), an avatar or a virtual object displayed in the display 206 can also be operated in response to the motions of the fingers of a user recognized by the camera 207. If the client terminals are not dedicated terminals for XR (smartphones), a virtual object displayed in the display 206 can be operated by operating the touch panel and the like of the display 206. Moreover, it is also possible to virtually come into contact with a virtual object or other avatars in a virtual space displayed in the display 206 by the synchronized fingers.

The interface 208 is an interface for an external device, and peripheral equipment such as various kinds of external sensors is connected therethrough. An operation of a virtual object and contact with other avatars in a virtual space can be realized by recognizing the fingers of a user in the real space using the camera 207. However, equivalent functions can also be realized by operating a dedicated controller connected to the interface 208. In addition, audio can be input by speaking into an audio input device such as a microphone connected to the interface 208. In addition, a headphone connected to the interface 208 allows a user to hear sound. The speaker 209 is a device converting an electrical signal in the client terminal into physical sound, and a user can hear sound provided by the virtual space provision system 111 or the client terminal through the speaker 209. A user may hear sound through the speaker 209 or may hear sound through an external device such as a headphone connected to the interface 208.

The network interface card (NIC) 211 is a network interface for exchanging data with an external device such as the virtual space provision system 111 via the networks 101 and 102. The constitution in FIG. 2 is an example, and the constitutions of the client terminals 121, 131, and 132 are not limited to this. For example, a storage location of data and programs can be changed to the ROM 204, the RAM 203, the HDD 205, or the like depending on the features thereof.

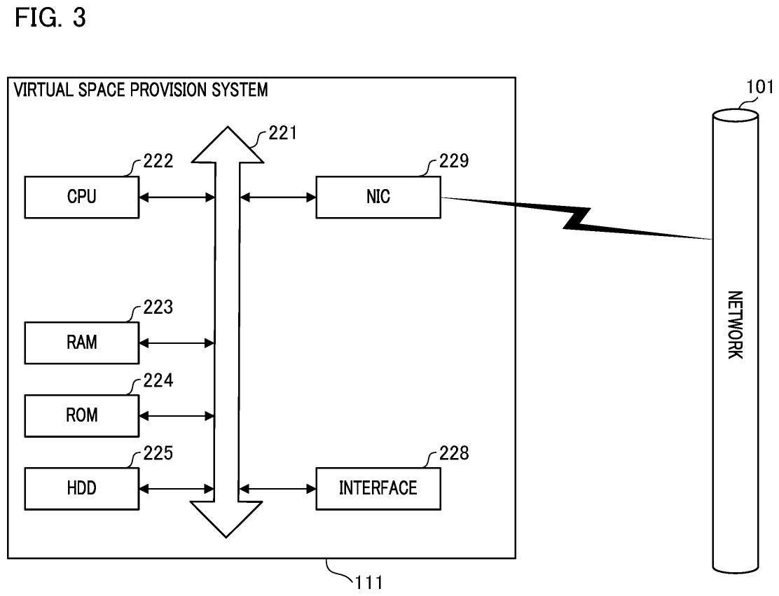

FIG. 3 is a view showing a hardware constitution of the virtual space provision system 111. The virtual space provision system 111 has a CPU 222, a RAM 223, a ROM 224, an HDD 225, an NIC 229, and an interface 228. These are connected to a system bus 221. The CPU 222 controls the virtual space provision system 111. The RAM 223 is a temporary storage means and functions as a main memory, a work area, and the like of the CPU 222. The ROM 224 is a data read-only memory and stores various kinds of data such as a basic I/O program. The HDD 225 is a mass memory and stores programs of a service server group, an operating system (OS), related programs, various kinds of data, and the like. The CPU 222 comprehensively controls every unit connected to the system bus 221 by loading and executing the program, which is stored in the memory (the ROM 224 or the HDD 225), in the RAM 203. The NIC 229 is a network interface for exchanging data with an external device such as the client terminals 121, 131, and 132 via the network 101. The interface 228 is an interface for an external device, and peripheral equipment is connected therethrough. The constitution in FIG. 3 is an example, and the constitution of the virtual space provision system 111 is not limited to this.

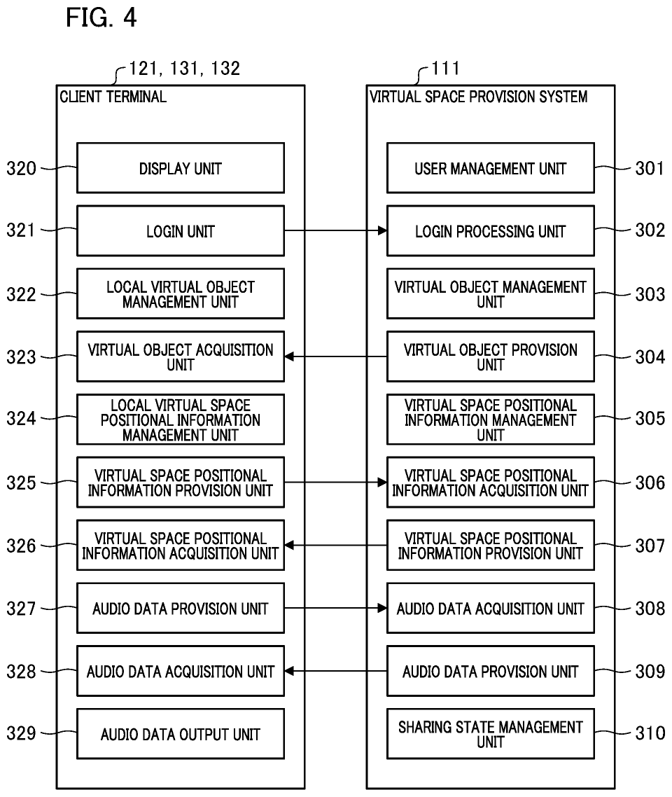

FIG. 4 is a view showing a software constitution of the system. The software constitutions of the client terminals 121, 131, and 132 shown in FIG. 4 are realized by the CPU 202 and the GPU 210 executing processing on the basis of the program stored in the memory (the ROM 204 or the HDD 205). Similarly, the software constitution of the virtual space provision system 111 shown in FIG. 4 is realized by the CPU 222 executing processing on the basis of the program stored in the memory (the ROM 224 or the HDD 225).

The virtual space provision system 111 has a user management unit 301 and a login processing unit 302 as functions for user management. In addition, as basic functions for providing a virtual space, the virtual space provision system 111 has a virtual object management unit 303, a virtual object provision unit 304, a virtual space positional information management unit 305, a virtual space positional information acquisition unit 306, and a virtual space positional information provision unit 307. In addition, as functions for providing system sound in a virtual space and audio of a user, the virtual space provision system 111 has an audio data acquisition unit 308 and an audio data provision unit 309. Moreover, the virtual space provision system 111 has a sharing state management unit 310 controlling a virtual object of a user avatar and the audio sharing state with respect to other users.

The user management unit 301 manages user information and login information. The login processing unit 302 receives a login request from the client terminals 121, 131, and 132, verifies it with user information managed by the user management unit 301, and returns a result of login processing to the client terminals 121, 131, and 132. Table 1 is an example of user information managed by the user management unit 301.

TABLE 1

| User | | Login | Term of validity |
|---|---|---|---|
| ID | Password | state | of login |
| user A | ********** | on | 2022 Dec. 31 0:00 |
| user B | ********** | on | 2022 Dec. 31 0:00 |
| user C | ********** | off | |

The column of User ID lists IDs uniquely identifying users. The column of Password lists passwords for basic authentication utilized at the time of login of the user ID. The login processing unit 302 performs user authentication by verifying the combination of the user ID and the password included in the login request from the client terminals 121, 131, and 132 with user information managed by the user management unit 301. Further, if the combination of the user ID and the password included in the login request matches the user information as a result of user authentication, the login processing unit 302 returns a login result indicating success to the client terminal of the transmission destination. Meanwhile, if the result of user authentication does not match it, a login result indicating failure is returned to the client terminal of the transmission destination. The column of Login state lists login states of users, in which “on” indicates a state of being logged in and “off” indicates a state of being logged out. The column of Term of validity of login lists the term of validity of the authentication state of a user who has logged in. The user authentication may be performed by biometric authentication such as facial authentication using a facial image captured by the camera 207, iris authentication using the iris, or fingerprint authentication utilizing a fingerprint sensor connected to the interface 208. If biometric authentication (fingerprint or the like) is utilized, a safer authentication method such as fast identity online (FIDO) can also be utilized. In that case, in a pair of a unique secret key generated in association with authentication information by an authenticator (not shown) of the client terminal and an open key, the open key is preregistered in an authentication system (RP server) provided in a virtual object management system.

The virtual object management unit 303 manages 3D data and the like of virtual objects disposed in a virtual space. Virtual objects also include avatars (user avatars and shared service avatars). The virtual object provision unit 304 provides 3D data managed by the virtual object management unit 303 to the client terminals 121, 131, and 132. Table 2 is an example of data of virtual objects managed by the virtual object management unit 303.

TABLE 2

| Virtual object | 3D data | Audio | Program |
|---|---|---|---|
| ID | UI | UI | data |
| object A | aaa.obj false | false | |
| System B | bbb.obj false | true | b.exe |
| System C | ccc.obj true | true | c.bat |

The column of Virtual object ID lists IDs uniquely identifying virtual objects in the virtual space. The column of 3D data lists data of 3D models in various kinds of formats. The column of UI lists whether the virtual object has a UI. It has a UI in the case of true, and it has no UI in the case of false. The column of Audio UI lists whether the virtual object has an audio UI. It has an audio UI in the case of true, and it has no audio UI in the case of false. Here, a UI denotes a user input means other than audio, and an audio UI denotes a user input means of only audio. The column of Program data lists program data of various kinds of formats related to 3D models. If the program data is blank, this denotes that the program is not associated with a 3D model. In addition, a virtual object having a UI or an audio UI is a shared service avatar. In the example shown in Table 2, the System B and the System C are shared service avatars. In response to an input of a user, the shared service avatar executes processing in accordance with the associated program data.

The virtual space positional information management unit 305 manages the positional information of virtual objects managed by the virtual object management unit 303. Table 3 is an example of a table of positional information of the avatar of each user managed by the virtual space positional information management unit 305.

TABLE 3

| User | Space | Main | Coordinates of | Coordinates of |
|---|---|---|---|---|
| ID | ID | coordinates | left hand | right hand |
| user A | room A | (100, 100, 5) | (100, 98, 5) | (100, 102, 5) |
| user B | room A | (100, 104, 5) | (100, 102, 5) | (100, 106, 5) |
| user C | room B | (200, 206, 5) | (200, 202, 5) | (200, 206, 5) |

The column of User ID lists IDs uniquely identifying users. The column of Space ID lists IDs uniquely identifying virtual spaces. The column of Main coordinates lists information indicating current positions (centers of gravity) of the avatars. The column of Coordinates of left hand lists information indicating positions of the left hands of the avatars. The column of Coordinates of right hand lists information indicating positions of the right hands of the avatars.

Table 4 is an example of positional information of virtual objects managed by the virtual space positional information management unit 305.

TABLE 4

| Virtual object | Space | Main |
|---|---|---|
| ID | ID | coordinates |
| object A | room A | (99, 100, 5) |
| System B | room A | (1, 2, 3) |
| System C | room B | (998, 999, 1000) |

The column of Virtual object ID lists IDs uniquely identifying virtual objects in the virtual space. The column of Space ID lists IDs uniquely identifying virtual spaces. The column of Main coordinates lists information indicating current positions (centers of gravity) of virtual objects.

The virtual space positional information acquisition unit 306 acquires the positional information from the client terminals 121 and 131 if there is a change in position of a virtual object or an avatar in a virtual space by an operation from the client terminals 121, 131, and 132 or regularly. The virtual space positional information acquisition unit 306 sends the acquired positional information to the virtual space positional information management unit 305. A virtual space positional information provision unit 325 provides the positional information of virtual objects or avatars in a virtual space managed by the virtual space positional information management unit 305 to the client terminals 121, 131, and 132.

The sharing state management unit 310 manages data for judging the virtual object or the audio sharing state. A user of a user avatar can share audio with a plurality of users via a plurality of other user avatars in the same virtual space. On the other hand, there may be cases where a user does not want other users to hear audio, such as during conversation with a shared service avatar provided by the virtual space provision system 111, or there may be cases where a user does not want to hear audio of other users. Hence, in the present Example, the audio sharing state with respect to a plurality of users can be controlled. Hereinafter, a state where the audio sharing state with respect to other users via a user avatar is canceled will be referred to as a private mode. Tables 5 and 6 show examples of data tables for management of the audio sharing state managed by the sharing state management unit 310. Table 5 is an example of a table of sharing condition management for management of information related to private mode conditions. In the table of sharing condition management, the private mode conditions are managed for each virtual object, that is, for each shared service avatar.

TABLE 5

| Virtual object | Private | Private mode |
|---|---|---|
| ID | mode | conditions |
| object A | false | |
| System B | true | within 50 of distance to |
| | | user avatar |
| System C | true | within 40 of distance to |
| | | user avatar, and System C |
| | | being in use |

The column of Virtual object ID lists IDs uniquely identifying virtual objects in the virtual space. The column of Private mode lists whether or not the private mode is set. Here, the private mode is a state where a virtual object of a user avatar and the audio sharing state is canceled. For example, a virtual object of a user avatar and the audio sharing state is canceled when the user avatar comes into contact with a particular virtual object such as a shared service avatar. Contact is detected when a user avatar comes near a particular virtual object such as a shared service avatar or a particular virtual object is used. In the case where the private mode is true, this indicates that a virtual object of a user avatar and the audio sharing state is canceled, and in the case of false, this indicates that it is not canceled. The column of Private mode conditions lists conditions for setting the private mode. That is, the column of Private mode conditions lists conditions for detecting contact with a particular virtual object such as a shared service avatar by a user avatar. For example, in the example shown in Table 5, contact is detected and the private mode is set if the distance to a user avatar is within a threshold in the System B and if the distance to a user avatar is within the threshold and a user is using the System C in the System C. Since the private mode of the object A is false, the private mode conditions are blank.

Table 6 is an example of a table of sharing state management showing information related to an application status of the private mode for each user. The application status of the private mode, that is, the audio sharing state is updated on the basis of judgment by the sharing state management unit 310 whether it satisfies the private mode conditions of the table of sharing condition management shown in Table 5.

TABLE 6

| User | Private | Private mode trigger |
|---|---|---|
| ID | mode | virtual object ID |
| user A | true | System B |
| user B | false | |
| user C | false | |

The column of User ID lists IDs uniquely identifying users. The column of Private mode lists whether users are in the private mode. In the case of true, this indicates that the private mode is set, and in the case of false, this indicates that the private mode is not set. The column of Private mode trigger virtual object ID lists virtual object IDs having private mode conditions which become trigger conditions for setting the private mode. In the example shown in Table 6, in the case of the user A, the private mode is set due to the condition “within 50 of distance to user avatar” that is the private mode condition of the System B in Table 5. Since the private mode is not set for the user B and the user C, the private mode trigger virtual object ID is blank.

In accordance with the table of sharing state management managed in Table 6, the sharing state management unit 310 controls audio data provided by the audio data provision unit 309. In the case of the example shown in Table 6, since the user A is in the private mode, the sharing state management unit 310 performs control such that audio of the user A is not shared with other users by the audio data provision unit 309. In addition, the sharing state management unit 310 performs control such that audio of other users is not shared with the user A by the audio data provision unit 309.

Next, software constitutions of the client terminals 121, 131, and 132 will be described. The client terminals 121, 131, and 132 each have a display unit 320, a login unit 321, a local virtual object management unit 322, and a virtual object acquisition unit 323. Moreover, the client terminals 121, 131, and 132 each have a local virtual space positional information management unit 324, the virtual space positional information provision unit 325, a virtual space positional information acquisition unit 326, an audio data provision unit 327, an audio data acquisition unit 328, and an audio data output unit 329.

The display unit 320 displays a virtual object or an avatar in a virtual space via the display 206. The login unit 321 transmits an image of the fingers captured by the camera 207 or the user name and the password input by an input device connected to the interface 208 to the login processing unit 302. The authentication method with respect to the virtual space provision system 111 may be facial authentication using a facial image captured by the camera 207, iris authentication using the iris, fingerprint authentication utilizing a fingerprint sensor connected to the interface 208, or the like.

The local virtual object management unit 322 manages information of 3D data or the like of a virtual object or an avatar acquired from the virtual space provision system 111 on the client terminals 121, 131, and 132. The virtual object acquisition unit 323 acquires information of 3D data or the like of a virtual object or an avatar from the virtual object provision unit 304 and saves it in the local virtual object management unit 322.

The local virtual space positional information management unit 324 manages the positional information of virtual objects or avatars in a virtual space acquired from the virtual space provision system 111 and shown in the table of user avatar positional information management (Table 3) and the table of virtual object positional information management (Table 4). In addition, the local virtual space positional information management unit 324 also has functions of detecting the position of a virtual object or an avatar, which has changed by an operation of the client terminals 121, 131, and 132, on the terminal of itself and saving the positional information in the local virtual space positional information management unit 324 itself. The virtual space positional information provision unit 325 transmits the positional information of virtual objects or avatars to the virtual space positional information acquisition unit 306 if there is a change in positional information in a virtual space by an operation of the client terminals 121, 131, and 132 or regularly. The virtual space positional information acquisition unit 326 regularly acquires the positional information of virtual objects or avatars from the virtual space positional information provision unit 307 and saves it in the local virtual space positional information management unit 324.

The audio data provision unit 327 transmits audio input by an audio input device such as a microphone connected to the interface 208 to the audio data acquisition unit 308. The audio data acquisition unit 328 acquires audio of other users, system sound, or background music (BGM) in a virtual space from the audio data provision unit 309. The audio data output unit 329 outputs audio data acquired by the audio data acquisition unit 328 through the speaker 209 or an external device such as a headphone connected to the interface 208. Due to these software constitutions, the client terminals 121, 131, and 132 can provide behavior, states, audio of virtual objects or other avatars in a virtual space provided by the virtual space provision system 111 to a user in real time.

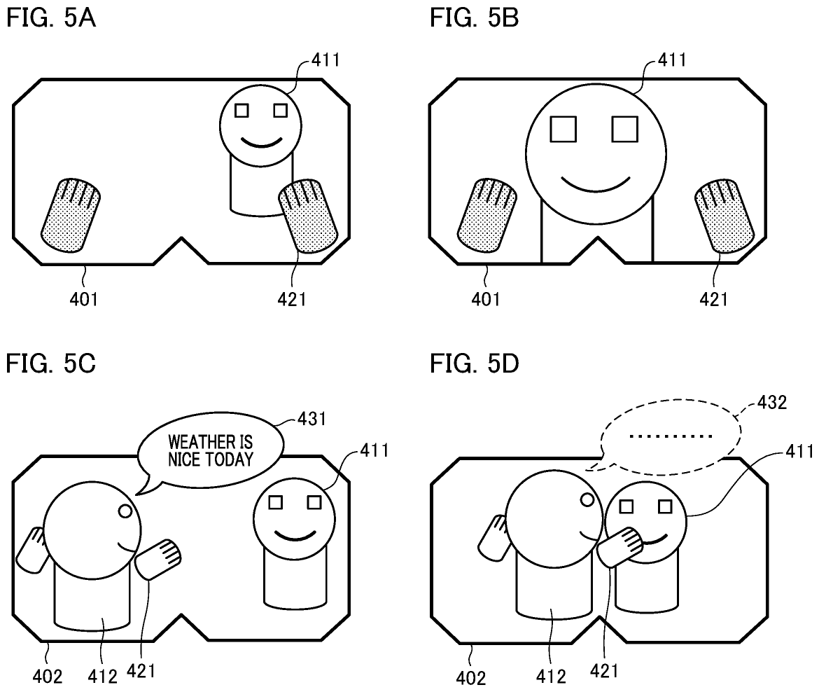

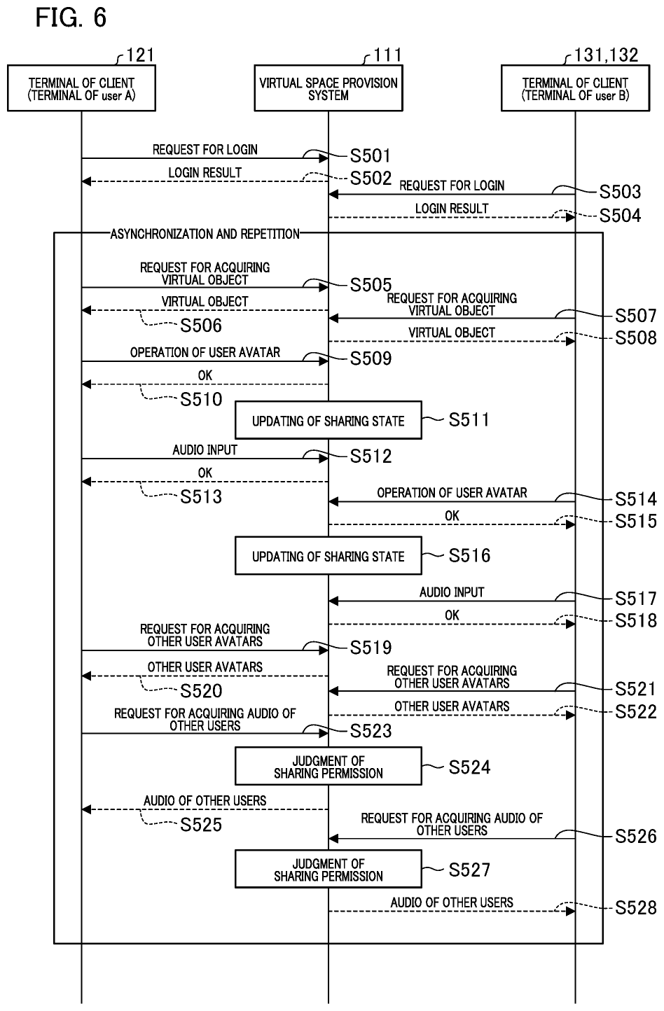

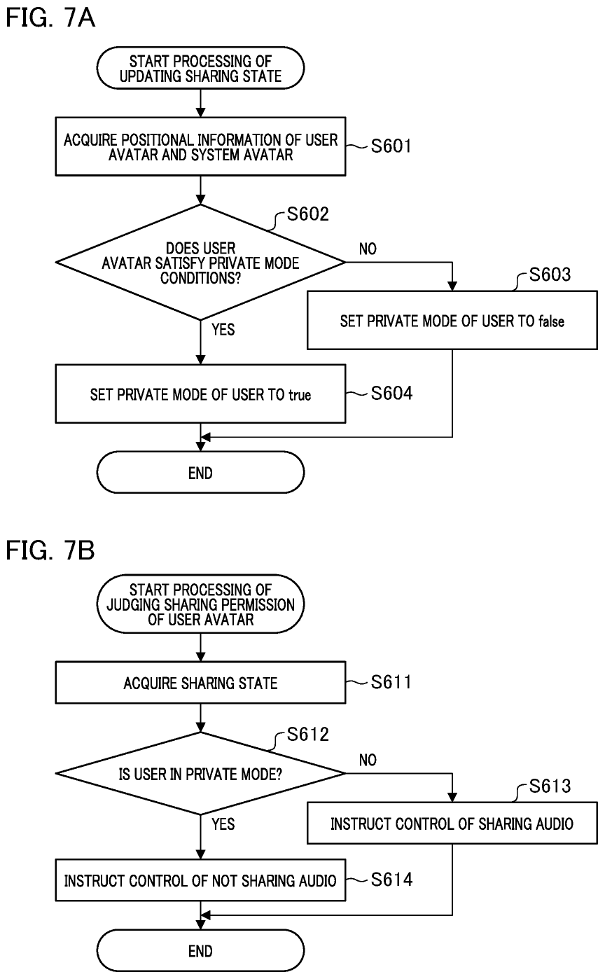

Using FIGS. 5A to 7B, a method for controlling an audio sharing state of a user in a virtual space will be described. FIGS. 5A to 5D are images in a virtual space displayed in the display 206 of the client terminals 121 and 131 and show an example of each of avatars for controlling the sharing state of user avatars in the present Example. FIG. 6 shows an example of a sequence until a user shares audio with other users or sharing is canceled. FIGS. 7A and 7B are flowcharts showing processing in the sequence of FIG. 6. Hereinafter, it is assumed that a user operating the client terminal 121 is a user having a user ID of user A in the column of User ID in Tables 1, 3, and 6. In addition, it is assumed that a user operating the client terminals 131 and 132 is a user having a user ID of user B in the column of User ID in Tables 1, 3, and 6.

FIGS. 5A to 5D are views showing an example of a screen of the client terminal according to Example 1. FIGS. 5A and 5B show images displayed in the display 206 of the client terminal 121 of the user A. That is, FIGS. 5A and 5B are images in a virtual space from the viewpoint of the user having a user ID of user A. A display 401 shows the display 206 of the client terminal 121 used by the user A. A virtual object 411 is a virtual object managed by the virtual object management unit 303. Here, it is assumed that the virtual object 411 is the virtual object having a virtual object ID of System B in the table of virtual object management (Table 2). A virtual object 421 is a virtual object indicating the fingers of the user avatar in the virtual space and is synchronized with motions of the fingers of the user (user A) in a real space.

FIG. 5A shows a state where the virtual object 421 (user avatar) has not come into contact with the virtual object 411 (shared service avatar). The distance between the user avatar in FIG. 5A and the virtual object of the System B, that is, the distance between the virtual object 421 and the virtual object 411 is longer than a distance 50 that is the private mode condition for the System B in the table of sharing condition management (Table 5). In the scene of FIG. 5A, since the virtual object 421 corresponding to the user A does not meet the private mode condition for the System B, the private mode is not set.

FIG. 5B shows a state where the virtual object 421 (user avatar) has come into contact with the virtual object 411 (shared service avatar). The distance between the user avatar in FIG. 5B and the virtual object of the System B, that is, the distance between the virtual object 421 and the virtual object 411 is shorter than the distance 50 that is the private mode condition for the System B in the table of sharing condition management (Table 5). In the scene of FIG. 5B, since the virtual object 421 corresponding to the user A meets the private mode condition for the System B, the private mode is set.

FIGS. 5C and 5D show images displayed in the display 206 of the client terminal 131 of the user B. The user B is in the same virtual space with the user A (in a specific example, a virtual space having a virtual space ID of room A). FIG. 5C is an image in the virtual space of the scene in FIG. 5A from the viewpoint of the user (user B). FIG. 5D is an image in the virtual space of the scene in FIG. 5B from the viewpoint of the user (user B). A display 402 shows the display 206 of the client terminal 131 used by the user B. A virtual object 412 indicates a virtual object of the user avatar of the user A. The hand of the virtual object 412 is the virtual object 421. A speech balloon 431 and a speech balloon 432 show audio emitted from the user avatar of the user A. Regarding the speech balloon 431 and the speech balloon 432, the speech balloons are not actually displayed in the display 206 as images, and they show that audio of the user A is emitted from the user avatar of the user A.

In the scene of FIG. 5A, the user A is not in the private mode, audio of the user A is shared with other users. For this reason, as shown in the speech balloon 431 in FIG. 5C, the user B can hear audio of the user A. Meanwhile, in the scene of FIG. 5B, since the user A is in the private mode, control is performed such that audio of the user A is not shared with other users. For this reason, as shown in the speech balloon 432 in FIG. 5D, the user B cannot hear audio of the user A.

Next, an overall processing sequence related to audio sharing will be described using FIG. 6. FIG. 6 is a sequence diagram of audio sharing control between users according to Example 1. FIGS. 7A and 7B are flowcharts of audio sharing control between users according to Example 1. Each step of the processing executed by the virtual space provision system 111 shown in FIGS. 6 to 7B is realized by the CPU 222 of the virtual space provision system 111 reading and executing the program stored in the memory in the RAM 223. Each step of the processing executed by the client terminal 121 shown in FIG. 6 is realized by the CPU 202 of the client terminal 121 reading and executing the program stored in the memory in the RAM 203. Each step of the processing executed by the client terminal 131 shown in FIG. 6 is realized by the CPU 202 of the client terminal 131 reading and executing the program stored in the memory in the RAM 203.

In S501, the login unit 321 of the client terminal 121 of the user A transmits the user ID and the password to the login processing unit 302 of the virtual space provision system 111. In S502, the login processing unit 302 of the virtual space provision system 111 performs user authentication with reference to the table of user management (Table 1) managed by the user management unit 301. In user authentication, the login unit 321 checks whether the user ID and the password match the user A. If they match up, a login result indicating that login has succeeded is returned to the client terminal 121.

In S503, the login unit 321 of the client terminal 131 of the user B transmits the user ID and the password to the login processing unit 302 of the virtual space provision system 111. In S504, similarly to S502, the login processing unit 302 of the virtual space provision system 111 performs user authentication with reference to the table of user management (Table 1) managed by the user management unit 301. In user authentication, the login unit 321 checks whether the user ID and the password which have been managed match the user B. If they match up, a login result indicating that login has succeeded is returned to the client terminal 131.

Thereafter, in S505 to S528, steps related to acquisition of each virtual object, an operation of a user avatar, updating of the sharing state, and sharing permission judgment are executed. Each step of the processing is executed asynchronously with other steps and regularly. In S505, the virtual object acquisition unit 323 of the client terminal 121 sends a request for acquiring a virtual object to the virtual object provision unit 304 of the virtual space provision system 111. In S506, the virtual space provision system 111 that has received a request for acquiring a virtual object transmits a virtual object (request source) to the client terminal 121. The virtual object acquisition unit 323 of the client terminal 121 acquires a virtual object from the virtual space provision system 111. A virtual object acquired in S506 is a virtual object of the table of virtual object management (Table 2) managed by the virtual object management unit 303. Similarly, in S507 as well, the virtual object acquisition unit 323 of the client terminal 131 sends a request for acquiring a virtual object to the virtual object provision unit 304 of the virtual space provision system 111. In S508, the virtual space provision system 111 that has received a request for acquiring a virtual object transmits a virtual object (request source) to the client terminal 131. The virtual object acquisition unit 323 of the client terminal 131 acquires a virtual object from the virtual space provision system 111. A virtual object acquired in S508 is a virtual object of the table of virtual object management (Table 2) managed by the virtual object management unit 303.

In S509, the user A operates a user avatar through the client terminal 121. At this time, the local virtual space positional information management unit 324 acquires the positional information or the like of the user avatar of the user A based on the operation of the user A and transmits the positional information from the virtual space positional information provision unit 325 to the virtual space positional information acquisition unit 306 of the virtual space provision system 111. The virtual space positional information management unit 305 that has acquired the positional information of the user avatar of the user A from the client terminal 121 updates the positional information of the user A of the table of virtual object management (Table 2) managed by the virtual object management unit 303. In S510, the virtual space positional information acquisition unit 306 returns the fact that reception of the positional information has been completed to the virtual space positional information provision unit 325 of the client terminal 121.

In S511, the sharing state management unit 310 judges whether audio of the user avatar of the user A is in a sharing state. The sharing state management unit 310 determines whether the private mode conditions are satisfied on the basis of contact with a shared service avatar by the user avatar, that is, on the basis of the positional information of the user avatar and the shared service avatar and updates the audio sharing state. Here, specific processing contents of processing of updating the audio sharing state shown in S511 will be described using the flowchart in FIG. 7A. FIG. 7A is a flowchart showing processing of updating the sharing state. In S601, the sharing state management unit 310 acquires the positional information of the user avatar and the shared service avatar from the virtual space positional information management unit 305. Specifically, the sharing state management unit 310 acquires coordinate information of the table of user avatar positional information management (Table 3) as the positional information of the user avatar and acquires coordinate information of the table of virtual object positional information management (Table 4) as the positional information of the shared service avatar.

In S602, the sharing state management unit 310 judges whether the user avatar satisfies the private mode conditions. The sharing state management unit 310 detects contact with the shared service avatar by the user avatar and judges whether the private mode conditions are satisfied. Specifically, the sharing state management unit 310 performs judgment by comparing the positional information (coordinate information) of the user avatar and the shared service avatar acquired in S601 and the private mode conditions of the table of sharing condition management (Table 5) with each other. If the coordinates of the user avatar and the shared service avatar acquired in S601 satisfy the private mode conditions, the sharing state management unit 310 judges that contact with the shared service avatar by the user avatar is detected and the private mode is set. If the coordinates of the user avatar and the shared service avatar acquired in S601 do not satisfy the private mode conditions, the sharing state management unit 310 judges that contact with the shared service avatar by the user avatar is not detected and the private mode is not set.

The sharing state management unit 310 executes the processing of S604 if it is judged that the private mode is set and executes the processing of S603 if it is judged that the private mode is not set. In S604, the sharing state management unit 310 sets the value for the column of Private mode shown in the table of sharing state management (Table 6) to true and ends this processing. In S603, the sharing state management unit 310 sets the value for the column of Private mode shown in the table of sharing state management (Table 6) to false and ends this processing.

In S512, the user A inputs audio through the client terminal 121. When audio input by the user A is detected, the audio data provision unit 327 of the client terminal 121 transmits audio input to the audio data acquisition unit 308 of the virtual space provision system 111. In S513, the audio data acquisition unit 308 returns the fact that reception of audio has been completed to the audio data provision unit 327 of the client terminal 121.

In S514, the user B operates a user avatar through the client terminal 131. At this time, the local virtual space positional information management unit 324 of the client terminal 131 acquires the positional information or the like of the user avatar of the user B based on the operation of the user B and transmits the positional information from the virtual space positional information provision unit 325 to the virtual space positional information acquisition unit 306. The virtual space positional information management unit 305 that has acquired the positional information of the user avatar of the user B from the client terminal 131 updates the positional information of the user B of the table of virtual object management (Table 2) managed by the virtual object management unit 303. In S515, the virtual space positional information acquisition unit 306 returns the fact that reception of the positional information has been completed to the virtual space positional information provision unit 325 of the client terminal 131.

In S516, the sharing state management unit 310 judges whether the user avatar of the user B is in the private mode. The processing of S516 is processing similar to the processing of S511. In S517, the user B inputs audio through the client terminal 131. When audio input by the user B is detected, the audio data provision unit 327 of the client terminal 131 transmits audio input to the audio data acquisition unit 308 of the virtual space provision system 111. In S518, the audio data acquisition unit 308 returns the fact that reception of audio has been completed to the audio data provision unit 327 of the client terminal 131.

In S519, the virtual object acquisition unit 323 of the client terminal 121 of the user A transmits a request for acquiring a user avatar to the virtual object provision unit 304 of the virtual space provision system 111. In S520, the virtual object provision unit 304 returns the user avatar in the same virtual space with the user A to the virtual object acquisition unit 323 of the client terminal 121.

In S521, the virtual object acquisition unit 323 of the client terminal 121 of the user B transmits a request for acquiring a user avatar to the virtual object provision unit 304 of the virtual space provision system 111. In S522, the virtual object provision unit 304 returns the user avatar in the same virtual space with the user B to the virtual object acquisition unit 323 of the client terminal 131.

In S523, the audio data acquisition unit 328 of the client terminal 121 of the user A transmits a request for acquiring audio of other users to the audio data provision unit 309 of the virtual space provision system 111. In S524, the sharing state management unit 310 judges permission of audio sharing depending on the sharing state of each user. The sharing state management unit 310 judges permission of audio sharing depending on the value of the column of Private mode with reference to the latest table of sharing state management (Table 6) updated by the processing of updating the audio sharing state. In S525, the audio data provision unit 309 returns audio of the user that can be shared to the audio data acquisition unit 328 of the client terminal 121.

Here, specific processing contents of processing of judging permission of audio sharing shown in S524 will be described using the flowchart in FIG. 7B. FIG. 7B is a flowchart showing processing of judging permission of sharing. In S611, the sharing state management unit 310 acquires the sharing state of the user shown in the table of sharing state management (Table 6) and proceeds to S612. In S612, the sharing state management unit 310 judges whether the user is in the private mode. Specifically, the sharing state management unit 310 judges that the private mode is set if the value of the column of Private mode of the table of sharing state management acquired in S611 is true and judges that the private mode is not set if the value thereof is false.

The sharing state management unit 310 executes S614 if it is judged that the private mode is set and executes S613 if it is judged that the private mode is not set. In S614, the sharing state management unit 310 controls the audio data provision unit 309 such that audio of other users is not temporarily shared with the user in the private mode and ends this processing. That is, in S614, control of temporarily canceling audio sharing with a plurality of users via the user avatar in the private mode is performed. In S613, the sharing state management unit 310 controls the audio data provision unit 309 such that audio of the user not in the private mode is shared with other users and ends this processing. In the example shown in Table 6, since the private mode of the user A is true, in S613, the sharing state management unit 310 controls the audio data provision unit 309 such that audio of other users is not shared with the user A. Due to control of preventing audio from being shared, in S525, audio of other users is not temporarily transmitted to the user A in the private mode.

In S526, the audio data acquisition unit 328 of the client terminal 131 of the user B transmits a request for acquiring audio of other users to the audio data provision unit 309 of the virtual space provision system 111. In S527, the sharing state management unit 310 judges permission of sharing depending on the sharing state of each user. Here, the processing of S527 is processing similar to the processing of S524. In S528, the audio data provision unit 309 returns audio of a user that can be shared to the audio data acquisition unit 328 of the client terminal 131. In the example shown in Table 6, since the private mode of the user A is true, in S613 during the processing of S527, the sharing state management unit 310 controls the audio data provision unit 309 such that audio of the user A is not shared with other users. Due to control of preventing audio from being shared, in S528, audio of the user A is not transmitted to the user B, and only audio of other users not in the private mode is transmitted to the user B.

In the present Example, the presence or absence of contact is detected and permission of audio sharing is judged under the condition of the distance between the user avatar and the shared service avatar, but the private mode conditions that become criteria for judging permission of audio sharing are not limited to the distance. For example, different conditions, such as the private mode being set if a user performs a particular gesture or speaks to a shared service avatar, may be adopted as the private mode conditions. By setting an operation with respect to a shared service avatar as the private mode condition, the virtual space provision system 111 can detect contact with a shared service avatar on the basis of a request for an operation based on audio or a gesture from a user avatar to the shared service avatar.

Hereinabove, description has focused on an example in which audio sharing is temporarily canceled. However, resuming of audio sharing is also controlled by the processing described in FIGS. 6 to 7B. In a state where audio sharing is temporarily canceled due to contact with a shared service avatar, if contact with the shared service avatar is no longer detected, audio sharing resumes. Specifically, in the processing of updating the sharing state (FIG. 7A) which is appropriately performed, when it is determined in S602 that the private mode conditions are not satisfied, the private mode of the user is updated to false in S603. In the processing of judging permission of sharing (FIG. 7B) thereafter, when it is determined in S612 that the private mode is false, a control instruction to share audio is issued in S613, and audio sharing resumes.

In addition, in a state where audio sharing is temporarily canceled due to contact with a shared service avatar, if a user is spoken to by other user avatars, even if audio has not been received, the user may be notified that he/she has been spoken to. For example, notification is displayed as a pop-up in the display 206. A user who has received the notification can cancel the private mode and restart audio sharing by stopping contact with a shared service avatar, such as by moving away from the shared service avatar. In addition, the notification may include an option as to whether or not to resume audio sharing. When an option of resuming audio sharing is selected by a user, the virtual space provision system 111 updates the private mode of the user to false in the processing of updating the sharing state and issues a control instruction to share audio. Accordingly, even if audio sharing is temporarily canceled, a user recognizes that he/she has been spoken to by other user avatars and can decide whether or not to share audio.

As above, in the present Example, permission of audio sharing is judged depending on contact between a user avatar and a shared service avatar in a virtual space, and audio sharing is controlled in accordance with the judgment of permission. Accordingly, audio can be input to a shared service avatar without allowing other nearby users to hear the contents in a virtual space. In addition, even when there are other users nearby, a shared service avatar can be used comfortably by not sharing audio.

### Example 2

In Example 1, the method for controlling audio sharing depending on the private mode state has been described. Even if a user speaks to another user in the private mode, audio is not shared and a conversation cannot be performed. Therefore, if other users are in the private mode, it is conceivable that a user desires to ascertain that they are in the private mode state. In Example 2, a method in which a user shares the private mode state will be described.

Table 7 is an example of a table of sharing condition management according to Example 2. The table of sharing state management is information related to the application status of the private mode for each user and is managed by the sharing state management unit 310. The table of sharing condition management (Table 7) is a table obtained by adding a column of Private mode state control to the table of sharing condition management shown in Table 5 described in Example 1.

TABLE 7

| Virtual object | Private | Private mode | Private mode state |
|---|---|---|---|
| ID | mode | conditions | control |
| object A | false | | |
| System B | true | within 50 of distance to | cancelation of audio |
| | | user avatar | sharing |
| | | | display of private |
| | | | mode state |
| System C | true | within 40 of distance to | cancelation of audio |
| | | user avatar, and System | sharing |
| | | C being in use | |

The column of Virtual object ID, the column of Private mode, and the column of Private mode conditions are the same as description in Table 6. The column of Private mode state control shows control performed in the case of being private. In the example shown in Table 7, the System C indicates that audio sharing is canceled as in Example 1, and the System B indicates that the fact of being in the private mode state is displayed for the user avatar in addition to cancelation of audio sharing. For this reason, if the user avatar comes into contact with the System B and is in the private mode, displaying indicating the fact that the user avatar is in the private mode is performed in addition to cancelation of audio sharing with other users. Since the private mode of the object A is false, the column of Private mode state control is blank. In this manner, in the present Example, a value for displaying the fact of being in the private mode state for other users can be stored in the column of Private mode state control.

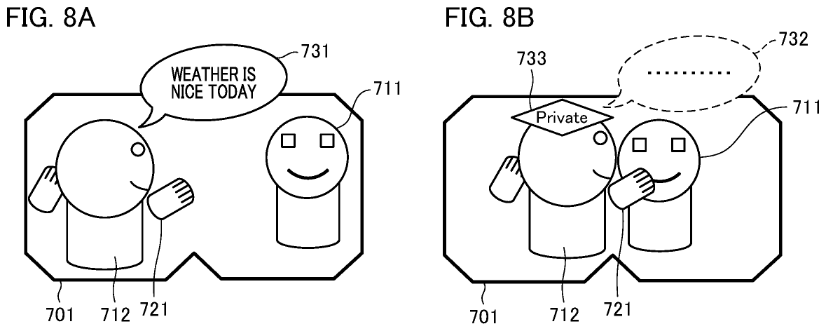

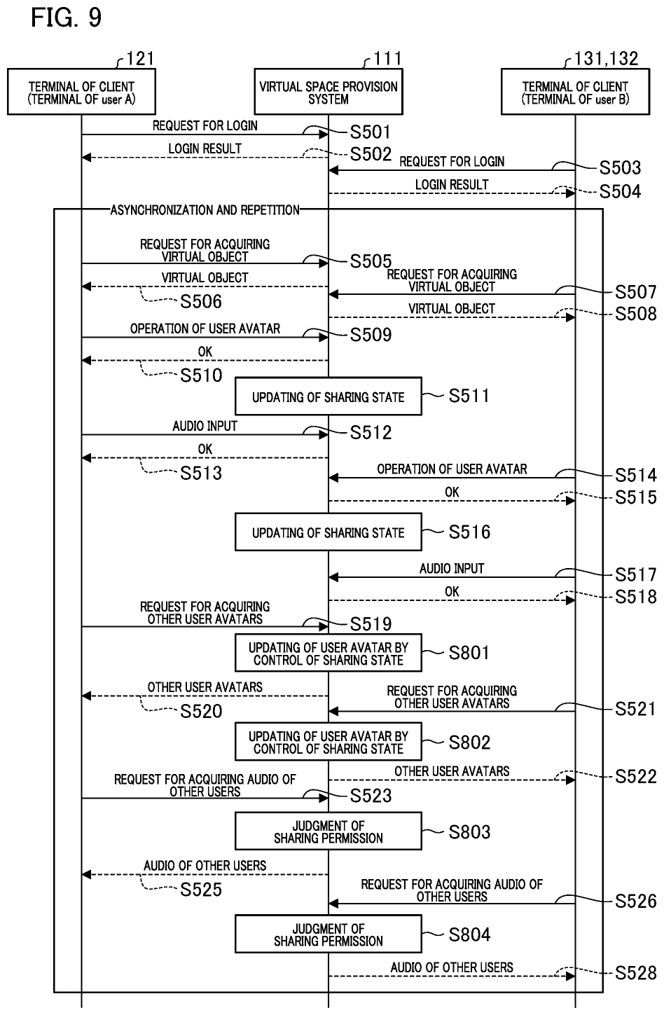

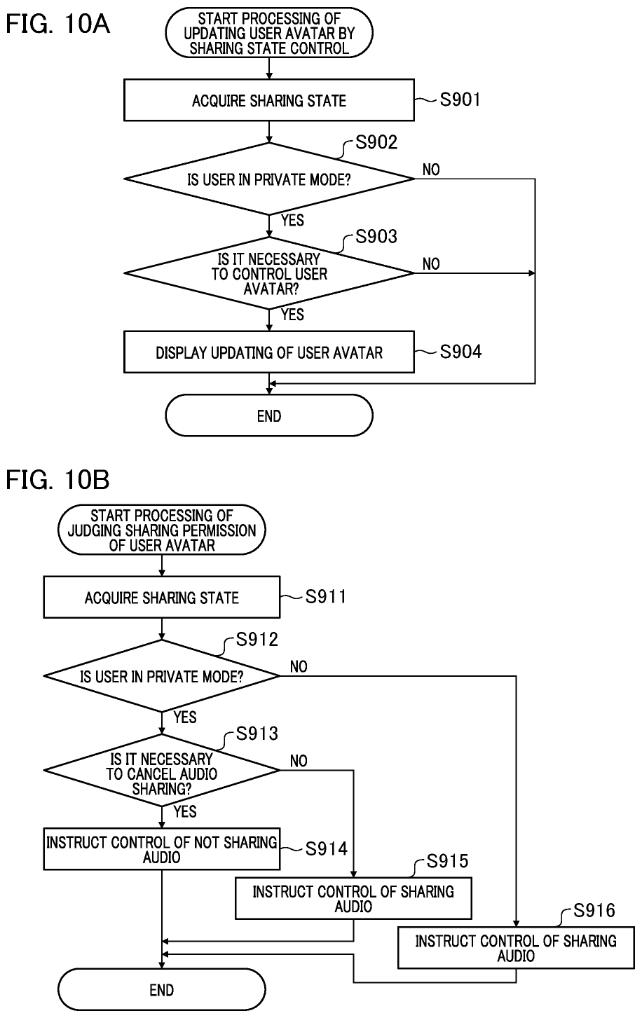

Using FIGS. 8A to 10B, a method for controlling a sharing state of a user in a virtual space according to Example 2 will be described. FIGS. 8A and 8B are images in a virtual space displayed in the display 206 of the client terminal 131 according to Example 2. FIG. 9 shows an example of a sequence until a user shares audio with other users or sharing is canceled. FIGS. 10A and 10B are flowcharts showing detailed processing in the sequence of FIG. 9. Hereinafter, it is assumed that a user operating the client terminal 121 is a user having a user ID of user A in the column of User ID in Tables 1, 3, and 6. In addition, it is assumed that a user operating the client terminals 131 and 132 is a user having a user ID of user B in the column of User ID in Tables 1, 3, and 6.

FIGS. 8A and 8B are views showing an example of a screen of the client terminal according to Example 2. FIG. 8A corresponds to the scenes in FIGS. 5A and 5C according to Example 1. FIG. 8B corresponds to the scenes in FIGS. 5B and 5D. FIG. 8A is an image in the virtual space of the scene in FIG. 5A from the viewpoint of the user having a user ID of user B managed by the table of user management (Table 1) according to Example 2. A display 701 shows the display 206 of the client terminal 131 used by the user B. A virtual object 711 is a virtual object (shared service avatar) managed by the virtual object management unit 303. Here, as an example, it is a virtual object having a virtual object ID of System B in the table of sharing condition management shown in Table 7. A virtual object 712 indicates a virtual object of the user avatar of the user A. A virtual object 721 is a virtual object indicating the fingers of the user avatar corresponding to the virtual object 712 in the virtual space, that is, the user A and is synchronized with motions of the fingers of the user A in a real space. Regarding a speech balloon 731, the speech balloon is not actually displayed in the display 206 as an image, and it shows that audio of the user A is emitted from the user avatar of the user A. In the scene of FIG. 5A, since the user A is not in the private mode, audio of the user A is shared with other users, so that the user B can hear audio of the user A. In addition since audio is in a shared state, a virtual object 733 indicating that audio shown in FIG. 8B is in an unshared state in a distinguishable manner for other users is not displayed.

FIG. 8B is an image in the virtual space of the scene in FIG. 5B from the viewpoint of the user having a user ID of user B managed by the table of user management (Table 1) according to Example 2. In the scene of FIG. 5B, since the user A is in the private mode, audio of the user A is not shared with other users. Therefore, the user B cannot hear audio of the user A. Regarding a speech balloon 732, a speech balloon is not actually displayed in the display 206 as an image, and it shows a state where audio of the user A cannot be heard from the user avatar of the user A. The virtual object 733 is displayed to show a state where the user A is in the private mode, that is, audio is not shared. In the examples in Tables 6 and 7, the user A is in the private mode due to the private conditions of the System B, and the private state control of the System B indicates cancelation of audio sharing and display of the private mode state. For this reason, audio of the user A is not shared with other users, and the virtual object 733 that is displaying for indicating that the user A is in the private mode is displayed along with the virtual object 712 of the user A.

Next, an overall processing sequence will be described using FIG. 9. FIG. 9 is a sequence diagram of audio sharing control between users according to Example 2. FIGS. 10A and 10B are flowcharts of audio sharing control between users according to Example 2. Each step of the processing executed by the virtual space provision system 111 shown in FIGS. 9 to 10B is realized by the CPU 222 of the virtual space provision system 111 reading and executing the program stored in the memory in the RAM 223. Each step of the processing executed by the client terminal 121 shown in FIG. 9 is realized by the CPU 202 of the client terminal 121 reading and executing the program stored in the memory in the RAM 203. Each step of the processing executed by the client terminal 131 shown in FIG. 9 is realized by the CPU 202 of the client terminal 131 reading and executing the program stored in the memory in the RAM 203. The same reference signs are applied to processing similar to the processing in FIG. 6 according to Example 1, and description thereof will be omitted.

In S519, the virtual object acquisition unit 323 of the client terminal 121 of the user A transmits a request for acquiring another user avatar to the virtual object provision unit 304. The virtual space provision system 111 that has received a request for acquiring a user avatar from the client terminal 121 performs the processing of S801. In S801, the sharing state management unit 310 updates the user avatar in response to control of the audio sharing state. Here, specific processing contents of S801 will be described using the flowchart in FIG. 10A.

FIG. 10A is a flowchart showing processing of updating the user avatar depending on the sharing state in S801. In S901, the sharing state management unit 310 acquires the audio sharing state of the user avatar of the user A from the table of sharing condition management (Table 7) and the table of sharing state management (Table 6) and proceeds to S902. In S902, the sharing state management unit 310 judges whether the user is in the private mode. Specifically, the sharing state management unit 310 judges that the private mode is set if the value of the column of Private mode of the table of sharing state management (Table 6) acquired in S901 is true and judges that the private mode is not set if the value thereof is false. The sharing state management unit 310 performs S903 if it is judged that the private mode is set. Meanwhile, the sharing state management unit 310 ends the processing if it is judged that the private mode is not set.

In S903, the sharing state management unit 310 judges whether it is necessary to control the user avatar. Specifically, the sharing state management unit 310 judges that it is necessary to control the user avatar when there is control related to the user avatar in the value of the column of Private mode state control of the table of sharing condition management (Table 7) acquired in S901 and judges that it is unnecessary to control the user avatar when there is no control. The sharing state management unit 310 performs S904 if it is judged that it is necessary to control the user avatar. Meanwhile, the sharing state management unit 310 ends the processing if it is judged that the private mode is not set. In S904, the sharing state management unit 310 issues an instruction to the virtual object provision unit 304 such that the user avatar of the user A is updated and provided in accordance with the private mode state control. If the processing of S801 is completed, the virtual space provision system 111 performs the processing of S520. In S520, the virtual object provision unit 304 returns the user avatar in the same virtual space with the user A to the virtual object acquisition unit 323 of the client terminal 121. At this time, if the user avatar is updated in S801, the user avatar is updated and the user avatar is returned to the virtual object acquisition unit 323 of the client terminal 121. In the examples in Tables 6 and 7, the private mode of the user B is false. Since the sharing state management unit 310 ends the processing without updating the user avatar corresponding to the user B in S801, the user avatar of the user B is transmitted to the user A without being updated in S520.

In S521, the virtual object acquisition unit 323 of the client terminal 131 of the user B transmits a request for acquiring another user avatar to the virtual object provision unit 304. In S802, the sharing state management unit 310 updates the user avatar in response to control of the sharing state. Here, the processing of S802 is processing similar to the processing of S801. When the processing of S802 is completed, the virtual space provision system 111 performs the processing of S523. In S523, the virtual object provision unit 304 returns the user avatar in the same virtual space with the user B to the virtual object acquisition unit 323 of the client terminal 131. At this time, if the user avatar is updated in S802, the user avatar is updated and the user avatar is returned to the virtual object acquisition unit 323 of the client terminal 131. In the examples in Tables 6 and 7, the private mode of the user A is true, and the private mode trigger virtual object ID is the System B. The private mode state control of the System B indicates cancelation of audio sharing and display of the private mode state. For this reason, in S801, the sharing state management unit 310 performs updating processing of adding the virtual object 733 indicating display of the private mode state to the user avatar of the user A in the private mode. Further, the user avatar of the user A having the virtual object 733 added thereto is transmitted to the user B in S522.

In S523, the audio data acquisition unit 328 of the client terminal 121 of the user A transmits a request for acquiring audio to the audio data provision unit 309 of the virtual space provision system 111. In S803, the sharing state management unit 310 judges permission of sharing on the basis of the audio sharing state of each user. Further, in S525, the audio data provision unit 309 returns audio of a user that can be shared to the audio data acquisition unit 328 of the client terminal 121 on the basis of the judgment result in S803. Here, specific processing contents in S803 will be described using the flowchart in FIG. 10B.

FIG. 10B is a flowchart showing processing of judging permission of sharing according to Example 2 shown in S803. In S911, with reference to Tables 6 and 7, the sharing state management unit 310 acquires the sharing state of the user and proceeds to S912. In S912, the sharing state management unit 310 judges whether the user is in the private mode. Specifically, the sharing state management unit 310 judges that the private mode is set if the value of the column of Private mode of the table of sharing state management (Table 6) acquired in S611 is true and judges that the private mode is not set if the value thereof is false. The sharing state management unit 310 executes S913 if it is judged that the private mode is set and executes S916 if it is judged that the private mode is not set. In S913, the sharing state management unit 310 judges whether it is necessary to cancel audio sharing. Specifically, the sharing state management unit 310 judges that it is necessary to cancel audio sharing when there is cancelation of audio sharing in the value of the column of Private mode state control of the table of sharing condition management (Table 7) acquired in S911 and judges that it is unnecessary to cancel audio sharing when there is no cancelation of audio sharing. The sharing state management unit 310 executes S914 if it is judged that it is necessary to cancel audio sharing and executes S915 if it is judged that it is unnecessary.

In S915, the sharing state management unit 310 controls the audio data provision unit 309 such that audio of a user not in the private mode is shared with other users. In addition, in S916 as well, similarly to S915, the sharing state management unit 310 controls the audio data provision unit 309 such that audio of a user not in the private mode is shared with other users. In S914, the sharing state management unit 310 controls the audio data provision unit 309 such that audio of a user in the private mode is not shared with other users.

In the examples shown in Tables 6 and 7, the private mode of the user A is true, and the corresponding private mode state control indicates cancelation of audio sharing and display of the private mode state. Meanwhile, the private mode of the user B is false. For this reason, in S914, the sharing state management unit 310 controls the audio data provision unit 309 such that audio of other users is not shared with the user Ain the private mode. Due to control of preventing audio from being shared, in S525, audio of other users is not transmitted to the user A in the private mode.

In S526, the audio data acquisition unit 328 of the client terminal 131 of the user B transmits a request for acquiring audio to the audio data provision unit 309 of the virtual space provision system 111. In S804, the sharing state management unit 310 judges permission of sharing based on the sharing state of each user. Here, the processing of S804 is processing similar to S803. In S528, the audio data provision unit 309 returns audio of a user that can be shared to the audio data acquisition unit 328 of the client terminal 131 in accordance with the judgment result in S804.

In the examples shown in Tables 6 and 7, the private mode of the user A is true, and the corresponding private mode state control indicates cancelation of audio sharing and display of the private mode state. Meanwhile, the private mode of the user B is false. For this reason, in S914, the sharing state management unit 310 controls the audio data provision unit 309 such that audio of the user A in the private mode is not shared with other users. Due to control of preventing audio from being shared, in S528, audio of the user A is not transmitted to the user B, and only audio of other users not in the private mode is transmitted to the user B.

In the present Example, an example in which the fact of being in the private mode is displayed in a distinguishable manner for other users by controlling display of a virtual object displaying the fact of being in the private mode in the user avatar in which audio sharing has been canceled has been described, but it is not limited to this. For example, a symbol may be displayed as a virtual object displaying the fact of being in the private mode, or other users may be informed of being in the private mode by changing the display form, such as by changing color, transparency, or brightness of a user avatar or by blinking. In addition, a user avatar in which audio sharing has been canceled may be controlled such that it is not displayed in a virtual space.

According to the present Example, it is possible to know whether other users are in the private mode by adding control of displaying in the case of the private mode to the private mode state control of the table of sharing state management. Accordingly, display of a user avatar can be controlled in accordance with control of audio sharing, and thus a user can ascertain the state of audio sharing.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-014029, filed Feb. 1 2023, which is hereby incorporated by reference wherein in its entirety.

What is claimed is:

1. A provision system providing a virtual space and a shared service avatar capable of receiving contact from a user avatar in the virtual space, the provision system comprising:
a memory storing instructions; and
a processor executing the instructions causing the provision system to:
control audio sharing between a plurality of users respectively operating a plurality of user avatars if a plurality of user avatars operated by users are present in a virtual space; and
detect contact with the shared service avatar by a user avatar of the plurality of user avatars,
wherein in response to detection of the contact, the processor performs control such that audio sharing with the plurality of users via a user avatar which has come into contact with the shared service avatar is temporarily canceled.

2. The provision system according to claim 1,
wherein contact with the shared service avatar is detected on the basis of a request for an operation based on audio or a gesture from a user avatar to the shared service avatar.

3. The provision system according to claim 1,
wherein contact with the shared service avatar is detected on the basis of positional information of a user avatar and the shared service avatar.

4. The provision system according to claim 1,
wherein in accordance with a state where the contact is no longer detected in a user avatar in which audio sharing is canceled, the processor performs control such that audio sharing with the plurality of users via the user avatar resumes.

5. The provision system according to claim 1,
wherein conditions for detecting contact with a shared service avatar are managed for each shared service avatar.

6. The provision system according to claim 1,
wherein a user avatar which has come into contact with the shared service avatar and in which audio sharing has been canceled is controlled to perform display allowing a plurality of other users to distinguish that audio sharing has been canceled.

7. The provision system according to claim 1,
wherein if there is a user avatar which has come into contact with a user avatar which has come into contact with the shared service avatar and in which audio sharing has been canceled, the processor notifies a user of the user avatar which has come into contact and in which audio sharing has been canceled of contact.

8. A control method for a provision system providing a virtual space and a shared service avatar capable of receiving contact from a user avatar in the virtual space, the control method comprising:
a step of controlling audio sharing between a plurality of users respectively operating a plurality of user avatars if a plurality of user avatars operated by users are present in a virtual space; and
a detection step of detecting contact with the shared service avatar by a user avatar of the plurality of user avatars,
wherein in response to detection of the contact, control is performed such that audio sharing with the plurality of users via a user avatar which has come into contact with the shared service avatar is temporarily canceled.
